(19) United States
(12) Patent Application Publication
(10) Pub. No.: US 2005/0007071 A1
(43) Pub. Date: Jan. 13, 2005

(54) Circuit arrangement for an autonomous power supply system, and a method for its operation

(76) Inventors: Jens Colberg, Bindow (DE); Kay Koster, Fredersdorf (DE); Harald Walter, Berlin (DE)

Correspondence Address: MORRISON & FOERSTER LLP, 1650 TYSONS BOULEVARD, SUITE 300, MCLEAN, VA, 22102, US

(21) Appl. No.: 10/850,442

(22) Filed: May 21, 2004

Related U.S. Application Data
(60) Provisional application No. 60/472,754, filed on May 23, 2003.

(51) Int. Cl. H02J 7/00

(52) U.S. Cl. 320/119

(57) ABSTRACT

At least two parallel battery paths are provided which functionally have equal authority and each of whose capacities is sufficient to supply a load on its own for a specific time period. By arranging a switch in each battery path, both at the current generator end and at the load end, respectively, by means of which switches the respective battery path can be disconnected from the power supply system by a control unit for investigations on the battery, while the other battery paths continue to supply the load.

### CLAIM FOR PRIORITY

This application claims the benefit of priority to U.S. Provisional Application No. 60/472,754, filed in the German language on May 23, 2003, the contents of which are hereby incorporated by reference.

### TECHNICAL FIELD OF THE INVENTION

The invention relates to a circuit arrangement for an autonomous power supply system, and in paricutlar, in which batteries can be charged via at least one current generator. The invention also relates to a method for operation of the power supply system.

### BACKGROUND OF THE INVENTION

Systems such as these have the characteristic feature that the rating of the respective generator is generally designed to be (significantly) less than would be necessary for the peak consumption of the load to be supplied. In the end, the size of the generator is governed by calculations relating to the time profile of the energy demand and analyses of the balance between the energy generation and consumption. The smallest-possible generator is generally used, for cost and space reasons.

One requirement for systems such as these is to reduce the effort for service and maintenance to an absolute minimum, and to ensure virtually maintenance-free operation. One characteristic feature of this is that the system should not generate a fault message at all unless irreparable damage, the end of the life expectancy of the energy stores or the loss of the generator is confirmed. If serious faults such as these are identified, the system must have an availability reserve such that the power supply can be maintained over a defined remaining time before a maintenance action is carried out.

The stated requirements occur, for example, in the case of high-availability local power supplies, preferably such as those used in railroad protection technology, in mobile radio systems or maritime navigational aids.

These objectives are not known in the field of conventional autonomous power supply technology, since solar power and wind power systems are primarily used for supplying low-priority loads.

It is known for batteries in mobile systems to be monitored continuously by means of appropriate displays. This method is not suitable for autonomous systems that are relevant to safety, security or availability, since it is impossible to monitor the state of the system continuously. A further fundamental problem is immediate availability and replacement with spare batteries at short notice.

It is also known for an autonomous power supply to be equipped with a main energy store and an auxiliary or emergency energy store, with an alkaline primary battery generally being used for the auxiliary or emergency energy store. The main energy store has a sufficiently large capacity and supplies the load in normal conditions, while normal operation is maintained for only a short time by the auxiliary or emergency energy store, which operates in the buffer mode, if the main energy store is damaged or exhausted. This solution allows a greater reaction capability, but does not match the required method of operation. Firstly, one problem is that the emergency battery must be replaced at the same time when maintenance is carried out on the main battery. However, the auxiliary or emergency energy store cannot be monitored for functionality since this is associated with the necessity to discharge it. If a rechargeable battery is to be used as the auxiliary or emergency energy store, this necessitates separate charging, buffering and monitoring, as well as active connection in the event of damage to the main battery, as well.

EP 1 072 493 A1 also discloses the use of a changeover switch to switch between two battery paths. However, in this case, the current flow is interrupted briefly during the switching process, and this is in principle undesirable. Uninterruptible switching is impossible in this case, since uncontrollable equalizing currents flow during the overlap of the switching states of the contacts, and these lead to discharging of the battery that is at the higher voltage level. There is no monitoring of the functionality of the battery that is currently not connected to the load.

Methods are also known for determination of the state of charge of batteries by direct measurement of the electrolyte concentration or by assessment of the voltage or of the current that is drawn by the load. The former necessitates the use of special batteries with integrated sensors, which require intensive maintenance, while assessment based on electrical characteristic variables and calculation based on various simulation models in different fields of use are subject to excessive errors. In the case of autonomous systems in the island mode, measurement errors are integrated over time, so that the assessment then become unusable.

Recalibration in systems such as these is impossible, since it is impossible for the batteries to reach the completely charged state when the load is continuously drawing current from them. On the other hand, complete discharging of the energy store down to the final discharge voltage in order to obtain a second possible calibration point represents an operating state that is not acceptable for system operation.

### SUMMARY OF THE INVENTION

The invention disclsoes a circuit arrangement for supplying power autonomously, by means of which the system is itself able to assess the state of its batteries, and to trigger an alarm only in a critical state.

The invention relates to a circuit arrangement for an autonomous power supply system by means of batteries which can be charged via at least one current generator, for feeding any desired electrical devices such as controllers, communication devices, lamps, motors or the like, to be precise systems which operate autonomously in field conditions. This relates to energy generation, storage and the supplying of the load in conditions where there is no appropriate infrastructure for auxiliary energy or additional energy that can be supplied externally, with the aim preferably being to use generators which generate energy on a randomly distributed basis, such as photovoltaic and wind power systems, or else very-high-efficiency generators which are supplied solely with primary energy, such as fuel cells, or combinations of both types of generator. The invention also relates to a method for operation of the power supply system.

The energy store is accordingly subdivided into at least two parallel battery paths which functionally have equal authority and each of whose capacities is sufficient to supply a load on its own for a specific time period. A switch is arranged in each battery path both at the current generator end and at the load end, respectively, by means of which switches the respective battery path can be disconnected from the power supply system by a control unit for the purpose of investigations on a battery, while the other battery paths take over the supply of the load.

At the load end, the battery paths are expediently decoupled at least by diodes, so that it is possible to switch between battery paths without any interruption.

One advantage of the circuit arrangement is that, on the one hand, it is possible to continue to operate the power supply system when damage occurs in one battery path and, on the other hand, the disconnected battery path can be investigated.

The battery (which has been fully charged by the generator and has been disconnected from the load) in a disconnected battery path can be discharged in a defined manner via a discharge circuit that can be connected, in order to determine its capacity.

It is thus possible, for example, to test the state of a battery by a simple voltage measurement and a time control without any stringent accuracy requirements, and to carry out an analysis of its aging and life expectancy by a comparison with data stored in the measurement system for previous measurements. There are no integration errors caused by time-dependent measurement processes or recalibration processes. Fully automatic operation over long time periods is thus feasible.

If this battery test is carried out at sensibly chosen periodic time intervals, it is possible to determine how the batteries have withstood time periods in extreme conditions for the power supply system (low or high temperatures, overcharging, severe cycling), and whether they still have the necessary capacity for a further time period of operation, for example winter operation.

The assessment of damage to batteries is also advantageous. If the voltage falls suddenly in one battery path, the controller first of all switches over to another battery path to supply the load. A comparison with the measurement data that is stored for the battery path that has been found not to be operating correctly and recharging which may possibly be carried out provide information as to whether an extraordinary event on the load has led to a very severe discharge, for example as a result of a temporary short circuit, or else a cell short circuit within the battery. If the system has stored the profile of the most recent discharge characteristic, a partial discharge is sufficient to assess the battery state. If the profile of the discharge characteristic of the partial discharge that has been initiated is within a narrow tolerance range of that most recently measured, then a temporary external short circuit has occurred. If the voltage on connection of the discharge resistor differs (severely) by more than the tolerance of the most recent discharge characteristic, a cell short circuit can be assumed.

Further investigations may be carried out in addition to the described tests. For example, it is possible to deduce the instantaneous state of charge of the battery from a single measurement of the no-load voltage. The self-discharge can be determined as a sign of aging by means of a no-load voltage test, with two voltage measurements in one time interval, on a battery which has been disconnected from the power supply system.

If the load is operated for a specific time period without a generator, that is to say by the battery in one battery path, the amount of energy required by the load can be determined, and the time to discharge the respective battery is calculated back from this load test. In addition, in the event of changes in the load behavior resulting from external influences (short circuits, heavy load, change in the operating regime), it is possible to calculate the shortening of the discharge time resulting from this.

In the case of power supply systems in the island mode, different strategies may be used for switching between charging, load supply and standby, based on the knowledge of the battery capacities and states of charge in the individual battery paths. The aim of the control process is to achieve or maintain the maximum energy content in the batteries. At least three basic variants of switching strategies are worthwhile, between which an automatically operating controller can decide autonomously depending on the energy introduced by the current generator and/or the energy consumed by the load.

In one variation, the controller to switch between the battery paths for supplying the load based on the time pattern of a reserve time selected by the operator, with the generator in each case recharging the battery which was most recently connected to the load. In this case, the power supply system always remains at a high storage capacity level, with the batteries being cycled only to a minor extent.

In a second variation, one battery path to be connected to the load and for this to be discharged until a critical discharge voltage is reached, which is used as a characteristic variable for the magnitude of the reserve capacity for supplying the load. In this case, each battery path is subjected to cycling, which also promotes long life. However, the batteries should not be operated down to the final discharge voltage since, in the event of a fault during the switching process to another battery path or as a result of damage in other battery paths or to the generator there must still be a sufficient amount of energy available to maintain operation, with a typical load profile, within the reserve time by switching back to the most recently discharged battery. In this variation, the generator gives charging priority to the battery that has been discharged to the greatest extent.

A third option is to control a pure standby mode. To do this, the generator and one battery path supply the load continuously. The other battery paths remain at readiness in the charged state. By cyclically switching the generator to another battery path in order to supply the load, the respective path is also recharged in order to compensate for the self-discharge. Since the daily energy balance is generally compensated for in this variation, it can be assumed that an energy store is virtually completely charged. Even though this state is the most desirable, the side effects of fully charged batteries depending on the chemical type must be borne in mind, since the life may also be drastically shortened.

Since none of the methods described above is suitable as such for optimum operation of the battery paths, the control system may possibly switch cyclically between these methods on the basis of the battery tests carried out on the individual battery paths, their states of charge and the amount of energy available, with the aim of exhausting the maximum life of the energy stores.

The functional procedures in the tests, as well as the recording of the measured data, are controlled by a computer in the control unit. The corresponding software may be stored in a processor or in other suitable memory media.

In addition to the switches being in the form of elements of contact, it is also possible to use power semiconductors with low forward resistances and a low-energy drive, for example MOSFET transistors.

The autonomous measurement of relevant current and voltage values allows suitable protection for the generator, for the storage elements, as well as for the load. On the other hand, the self-protection for the system that is built-in in this way makes it possible to counteract damage caused by externally occurring disturbances, so as to avoid destruction of the power supply system.

The complete range of the described measures results in high availability of the autonomous power supply. If a fault is identified in one storage element, or in the switches, the system can still be operated. The maintenance action can be initiated by suitable remote signaling in the control unit.

### BRIEF DESCRIPTION OF THE DRAWINGS

The invention will be explained in more detail in the following text with reference to exemplary embodiments. In the associated drawings:

FIG. 1 shows the circuit arrangement according to the invention with n battery paths.

FIG. 2 shows the circuit arrangement with two battery paths.

### DETAILED DESCRIPTION OF THE INVENTION

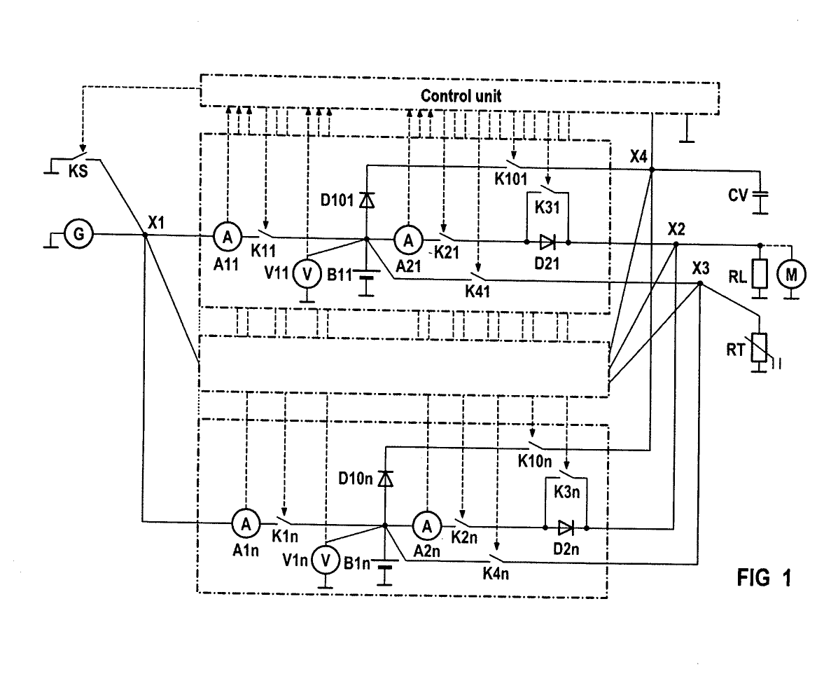

According to FIG. 1, the autonomous power supply system comprises a generator G which generates energy on a randomly distributed basis, such as photovoltaic or wind power generators, or a very-high-efficiency generator which is supplied with primary energy, such as fuel cells, or a combination of both generator types, with the rating of the generator being less than the peak load power that occurs, and two or more parallel battery paths B11, B12 . . . B1n of equal size, which alternately supply power to the load or are recharged from the generator G, depending on the state of charge.

There are n parallel paths between an input busbar X1, which is connected to the generator G, and an output busbar X2, which is connected to a load RL, comprising a series-connected input-side current measurement point A1n, a charging switch K1n as well as the battery B1n, with the positive pole of the battery B1n itself being connected to a second current measurement point A2n and, in series with this, by means of a switch K2n and the cathode side of the diode D2n to the output busbar X2. A further switch K4n is also connected to the positive pole of the battery B1n, and its second connection is connected to a busbar X3. Furthermore, the positive pole of the battery B1n is connected on the anode side to the decoupling diode D10n, while its cathode is connected to a further busbar X4n via a series-connected switched K10n. A voltage measurement point V1n is connected in parallel with the connections of each battery B1n.

The busbar X1 is in turn connected via a switch KS to ground, the busbar X3 is connected to ground via a test resistor RT, while the busbar X4 is connected to a capacitor CV (which is connected to ground in parallel) and to the positive connection point of a control unit. The control unit records the measurement variables from the current measurement points A1n, A2n, as well as the voltage measurement points V1n, and controls the switches KS, K1n, K2n, K4n and K10n.

In the normal operating state, the generator G is connected via the switch K1n to a charging path for a battery B1n. The current measurement point A1n records the charging current, the voltage measurement point V1n records the charging voltage, and the control unit determines the parameters for the state of charge, and switches off the generator G when the battery B1n is fully charged. A further battery path can then be connected via the respective switch to the generator G, and the charging procedure is carried out as described. If the batteries B1n have been charged and the load RL is not switched on (for example standby mode), the generator G may be short-circuited as a function of the characteristic by means of the switch KS in order to dissipate excess energy, or else may be operated on no-load by opening all of the switches K1.

In order to operate the load RL, a switch K2n that is selected by the control unit is switched on, and provides energy at the output via the diode D2n. If one battery B1n is exhausted, a second switch K2n switches on a second battery path. The positive potential difference of the newly connected battery B1n automatically results in the load current being commutated without any interruption to the newly connected battery B1n. The discharged battery path is then switched off, without any time criticality. The diodes D2n prevent parallel currents from flowing. The load RL can be operated with two or more battery paths connected, with the battery B1n with the highest voltage first of all taking over the entire load current until, as it discharges, other batteries B1n become involved in the supply of the load RL. However, the generator G may also be connected in a permissible manner to a battery B1n which is at the same time supplying the load RL.

The current measurement points A2n are used to record the discharge currents, and the voltage measurement point V1n is used to monitor the discharge voltage. The discharge is assessed in the control unit, or else the control unit controls the switches K2n for an overload situation and for positive disconnection in the event of a short circuit. A periodic capacity determination process is carried out in order to assess the aging state and to determine the remaining life of the batteries B1n in the autonomous power supply. For this purpose, the selected battery B1n is disconnected from the load RL by means of switches K2n, and is disconnected from the busbar X4 for its own power supply by means of switches K10n, and is charged by the generator G via the switch K1n until it reaches the final charge voltage; the generator G is then switched off, and the battery V1n is discharged by closing the switch K4n to the test resistor RT until the final discharge voltage is determined by the voltage measurement element V1n. In the simplest case, the test resistor RT comprises a linear resistance. Considerably more accurate results can be achieved by means of a current-regulated resistance with a constant-current discharge. Once the battery B1n has been discharged, the switch K4n is opened, and the battery B1n is once again connected via the switch K1n to the generator G for charging, as soon as the control unit has released the latter from charging another battery B1n. Furthermore, the battery B1n is coupled to the busbar X4 again, by the switch K10n.

Fundamentally, the distributed energy store is designed such that the capacity of n-1 batteries is sufficient to supply the load RL in order to reliably bridge the time for charging, discharging and recharging of the battery B1n to be tested, with a defined mean amount of energy being introduced. Apart from this, the overall storage capacity is designed on the basis of the load cycles, the load behavior and the possible energy generation.

The energy-storage capacitor CV bridges voltage dips in the power supply of the control unit resulting from short circuits which may occur on the load RL within the reaction time of the control unit to switch off the switches K2n.

One special feature relates to systems with a low output voltage, or else systems with motor loads, which can also recuperate braking energy. The insertion of an additional switch K3n in parallel with the diode D2n results in a bi-directional switch, which makes it possible to feed back energy that is released by an active load M into the batteries B1n. Furthermore, this avoids the power loss, which often cannot be ignored, resulting from the forward voltage across the diode D2n. In this case, switching from one path to the other first of all requires the switch K3n to be switched off, after which the switch K2n in the battery path to be connected can be operated. The previous battery path is switched off, and the switch K3n in the newly connected battery path is then switched on.

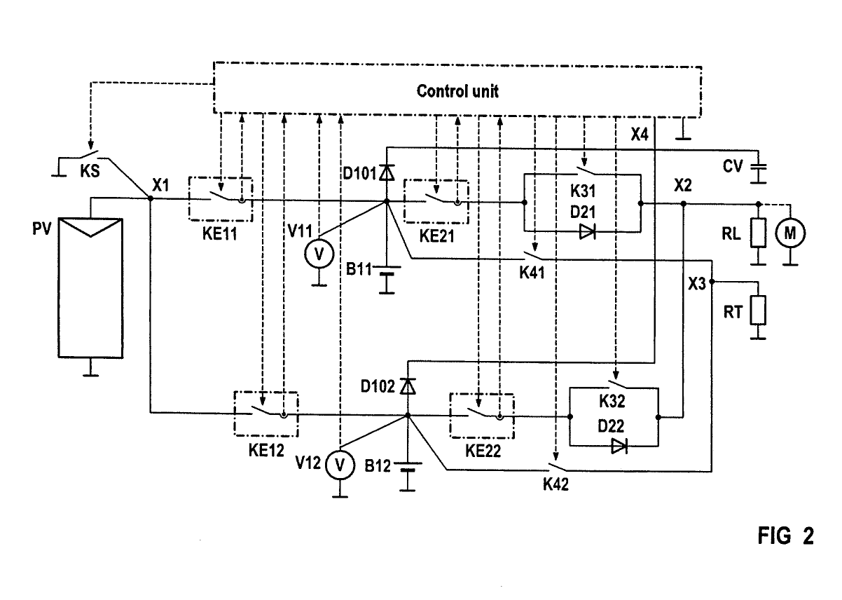

The exemplary embodiment shown in FIG. 2 relates to an autonomous power supply comprising a solar generator PV and two parallel battery paths B11, B12 as energy stores. The switches KE11 . . . KE22 are in the form of power-electronic switching units with integrated current measurement, the control unit comprises a microcontroller with a non-volatile memory for controlling the power semiconductors, and for administration, archiving and for comparison of measurement data.

The control unit's own supply is provided with a minimal energy demand, which is significantly less than the self-discharge of a battery B11, B12. This results in an embodiment in a form in which there is no need for the switches K10n. This solution is particularly practicable when the error during the test discharge of the batteries B11, B12 remains within the permissible limits.

One advantage of this example is also that the ground potential is always maintained by the elected arrangement of the switching elements, thus ensuring that the system parts are reliably grounded.

1. A circuit arrangement for an autonomous power supply system by batteries which can be charged via at least one current generator, comprising:
at least two parallel battery paths provided with functionally have equal authority and having capacities sufficient to supply a load on its own for a specific time period; and
a switch is arranged in each battery path both at the current generator end and at the load end, respectively, by means of which switches the respective battery path can be disconnected from the power supply system by a control unit for investigations on the battery, while the other battery paths continue to supply the load.

2. The circuit arrangement as claimed in claim 1, wherein each battery path is configured for connection to a discharge path by means of the switch.

3. The circuit arrangement as claimed in claim 1, wherein each battery path has a current measurement point at the generator end.

4. The circuit arrangement as claimed in claim 1, wherein ach battery path has a current measurement point at the load end.

5. The circuit arrangement as claimed in claim 1, wherein ach battery path has a voltage measurement point.

6. The circuit arrangement as claimed in claim 2 wherein the discharge path has a discharge resistor.

7. The circuit arrangement as claimed in claim 1, wherein the individual battery paths are decoupled from one another by means of diodes.

8. The circuit arrangement as claimed in claim 7, wherein the diodes can be bridged by a switch.

9. A method for supplying power autonomously to a load by batteries which can be charged via at least one current generator, comprising:
providing at least two parallel battery paths which functionally have equal authority and capacities sufficient to supply a load on its own for a specific time period; and
disconnecting each battery path from the power supply system, at defined points in time, by means of switches both at the current generator end and at the load end, respectively, for investigations on the battery, while the other battery paths continue to supply the load.

10. The method as claimed in claim 9, wherein the state of a battery which is disconnected from the power supply system is recorded and analyzed for measurement purposes by means of rest state recording, partial discharge or full discharge.

11. The method as claimed in claim 9, wherein in an island mode, the batteries are connected to the load in a selected time pattern and the battery which was in each case most recently connected to the load is recharged.

12. The method as claimed in claim 9, wherein in an island mode, the battery which is connected to the load is in each case discharged down to a defined discharge voltage, and the battery which has been discharged to the greatest extent is in each case recharged.

13. The method as claimed in claim 9, wherein in an island mode, the batteries are charged cyclically by the generator in the standby mode.

14. The method as claimed in claims 11, wherein switching takes place cyclically between the charging/discharge processes.
